(19) United States
(12) Patent Application Publication
(10) Pub. No.: US 2025/0348345 A1
(43) Pub. Date: Nov. 13, 2025

(54) VIRTUAL COMPUTING RESOURCE DEPLOYMENT DEVICE, PROGRAM, AND VIRTUAL COMPUTING RESOURCE DEPLOYMENT METHOD

(71) Applicant: Nippon Telegraph and Telephone Corporation, Tokyo (JP)

(72) Inventor: Hirofumi NOGUCHI, Musashino-shi, Tokyo (JP)

(21) Appl. No.: 18/869,331

(22) PCT Filed: Jun. 7, 2022
(86) PCT No.: PCT/JP2022/022931

§ 371 Date: Nov. 26, 2024

(51) Int. Cl. G06F 9/455; G06F 9/50

(52) U.S. Cl. CPC G06F 9/45558; G06F 9/5077; G06F 2009/45562; G06F 2009/4557; G06F 2009/45575

(57) ABSTRACT

A virtual computing resource deployment device includes: a container operation reception unit that receives a request for adding a new container from a user; and a container management unit that deploys the new container in a user-use virtual machine, as a virtual machine running a container added by request from the same user as said user. When a host computer running the user-use virtual machine (deployed-to virtual machine) has extra resources necessary for running the new container, the container management unit may instruct a virtual machine management unit, that manages increasing/decreasing resources of a virtual machine, to add the extra resources to the deployed-to virtual machine, and deploy the new container.

### TECHNICAL FIELD

The present invention relates to a virtual computing resource deployment device, a program, and a virtual computing resource deployment method for deploying a container in virtualized computer resources.

### BACKGROUND ART

Recent mainstream virtualization techniques include a virtual machine (VM) and a container. The virtual machine operates on a hypervisor running on a host computer, and an operating system (OS) (hereinafter, described as a guest OS) and an application run on the virtual machine. While the container operates on a container base running under the OS, and the application operates on the container. A plurality of containers shares the single OS.

Since a computer environment (computing resources) is isolated in units of virtual machines and containers, pieces of information of the users are not mutually violated even in a case where there is a plurality of users. However, a degree of isolation and a degree of hardware abstraction are different between the virtual machine and the container. T guest OS runs on the virtual machine to allow for handling hardware in a more abstracted way, and the one or more virtual machines can be provided on the single host computer. While the containers share the OS, so that a container has a higher security risk such as information leakage than a virtual machine.

The virtual machine and the container can be saved in data units called an image and restored (activated), and free/non-free images are distributed in the market. Note that the image of the virtual machine is used only as the virtual machine while the image of the container is used only as the container, to have no compatibility with each other.

The container can be used under the guest OS running on the virtual machine. Since the virtual machine and the container provide the same function from the viewpoint of virtualization, using both of them at the same time seems to be overlapping with each other, but actually, there are the following advantages. For some of software that operates in a virtual environment, a virtual machine image is not distributed, and only a container image is available. In a case where such software is used, configuring a container so as to run on a virtual machine allows for achieving strong isolation performance by the virtual machine while using the container image. Note that isolation for each user (tenant) is a very important requirement, especially for providing public cloud computing.

The most popular container base is Kubernetes described in Non-Patent Literature 1. Kubernetes manages a container execution environment in units called a node, and when a user specifies requested resources of the container, Kubernetes has a function of selecting a node having extra resources equal to or more than the requested resources and providing the container. When a request for a container comes from the user, a virtual machine is activated that has resources fulfilling the request and Kubernetes is used to provide the container in the virtual machine to realize the public cloud computing for providing the container to run on the virtual machine.

### CITATION LIST

### Non-Patent Literature

Non-Patent Literature 1: Resource Management for Pods and Containers, [online], The Kubernetes Authors, [Retrieved on May 19, 2022], the Internet <URL: https://kubernetes.io/docs/concepts/configuration/manage-resources-containers/>

### SUMMARY OF THE INVENTION

### Problems to be Solved

In the public cloud computing described above, a large number of virtual machines run on the host computer, to have a large overhead. The overhead is, for example, a storage area for data required in the container base or processing to operate the container base. In the public cloud computing described above, there are overheads as many as the number of the virtual machines that exist as many as the containers, and this is undesirable from the viewpoint of a resource utilization efficiency of the host computer. The present invention has been devised in view of such a background, and is intended to improve a resource utilization efficiency in a service of providing a container based on a virtual machine.

### Solution to Problem

In order to solve the above problems, a virtual computing resource deployment device according to the present invention to deploy a container to run in a virtual machine includes: a container operation reception unit that receives a request for adding a new container from a terminal used by a user; and a container management unit that deploys the new container in a user-use virtual machine, as a virtual machine running a container added by request from the terminal used by the same user.

### Advantageous Effects of Invention

The present invention improves a resource utilization efficiency in a service of providing a container based on a virtual machine.

### BRIEF DESCRIPTION OF DRAWINGS

FIG. 1 is a diagram illustrating an overall configuration of a virtual computer environment according to a first embodiment;

FIG. 2 is a functional block diagram of a host computer according to the first embodiment;

FIG. 3 is a functional block diagram of a virtual computing resource deployment device according to the first embodiment;

FIG. 4 is a data formation chart of a host resource database according to the first embodiment;

FIG. 5 is a data formation chart of a container management database according to the first embodiment;

FIG. 6 is a sequence diagram of a container addition process according to the first embodiment;

FIG. 7 is a sequence diagram of a container deletion process according to the first embodiment;

FIG. 8 is a sequence diagram of a container deployment optimization process according to the first embodiment;

FIG. 9 is a sequence diagram of a container addition process according to a second embodiment;

FIG. 10 is a sequence diagram of a container deletion process according to the second embodiment; and

FIG. 11 is a hardware configuration diagram illustrating an example of a computer that implements functions of the virtual computing resource deployment device according to each of the first and second embodiments.

### DESCRIPTION OF EMBODIMENTS

Hereinafter, a virtual computer environment including a virtual computing resource deployment device according to an embodiment of implementing the present invention is described. When receiving a request for a container from a user, the virtual computing resource deployment device deploys (provides, runs, activate) the requested container in a virtual machine in which one or more containers for the user (container requested by user) are in operation.

More specifically, the virtual computing resource deployment device finds (searches for) a virtual machine in which the user's one or more containers (also referred to as virtual machine for the user, user-use virtual machine, or the like) are in operation. The virtual computing resource deployment device increases resources of the user-use virtual machine so as to allow the container to run, and deploys the container. When there is no user-use virtual machine or when a host computer has no resources and the resources cannot be increased, a virtual machine is newly activated in a host computer in which no user-use virtual machine run, and a container is deployed in the activated virtual machine. When the container is deleted, the virtual computing resource deployment device deletes the container and reduces resources used by the container from the virtual machine in which the deleted container has been in operation.

Using such a virtual computing resource deployment device causes users of containers running in a single virtual machine to be identical. Containers for different users run in different virtual machines, to ensure security equivalent to that in a conventional environment. Furthermore, the resources of the virtual machine are adjusted in accordance with the deployment and deletion of the container, so that the virtual machine runs with minimum resources required for running one or more containers. The number of virtual machines for the identical user running in the single host computer is equal to or less than one. Therefore, a high resource utilization rate can be realized.

### Configuration of Virtual Computer Environment

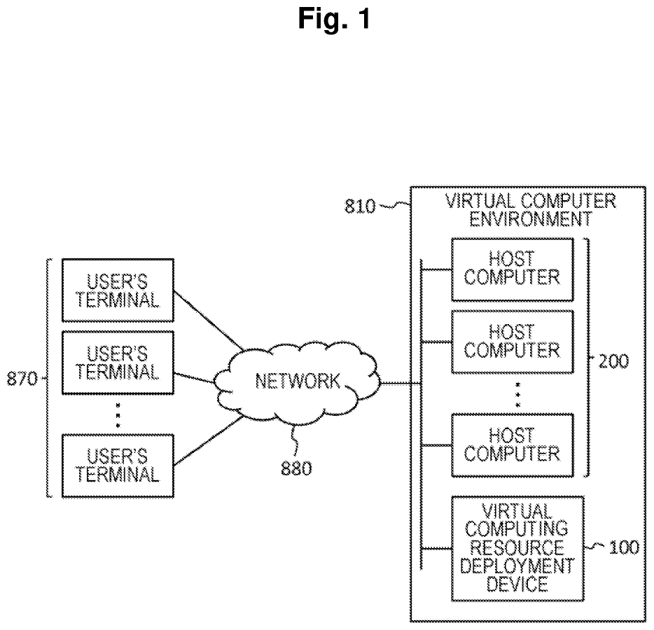

FIG. 1 is a diagram illustrating an overall configuration of a virtual computer environment 810 according to a first embodiment. The virtual computer environment 810 includes one or more host computers 200 and a virtual computing resource deployment device 100.

### Configuration of Host Computer

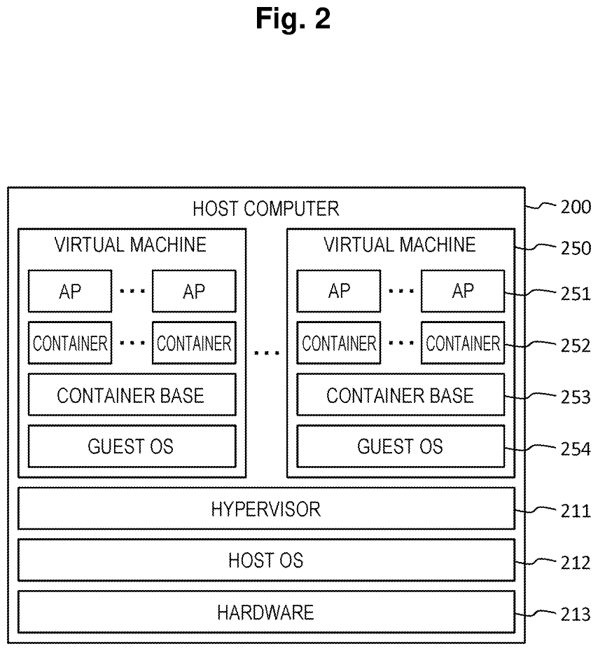

FIG. 2 is a functional block diagram of the host computer 200 according to the first embodiment. A host OS 212 runs on hardware 213 of the host computer 200, and a hypervisor 211 runs under the host OS 212. One or more virtual machines 250 run on the hypervisor 211. In response to an instruction from the virtual computing resource deployment device 100, the hypervisor 211 activates or stops (deletes) the virtual machine 250 and increases or decreases the number of CPU cores and an amount of memory used by (allocated to) the virtual machine 250.

In the virtual machine 250, a guest OS 254 runs, a container base 253 runs under the guest OS 254, and one or more containers 252 and applications 251 (described as AP (application) in FIG. 2) run on the container base 253. Note that, in the first embodiment, the mode described above is assumed as the container technique, but another mode of the container technique may be used. In response to the instruction from the virtual computing resource deployment device 100, the container base 253 activates (adds) and stops (deletes) the container 252 and the application 251, and moves the container 252 and the application 251 between the virtual machines 250.

The users of the containers 252 running in the single virtual machine 250 (user who has requested adding/activating/deploying the container 252) are identical. Furthermore, the users of the containers 252 running in the plurality of virtual machines 250 running in the single host computer 200 are different from each other. In other words, in the single host computer 200, the single virtual machine 250 runs the containers 252 for the single user.

### Configuration of Virtual Computing Resource Deployment Device

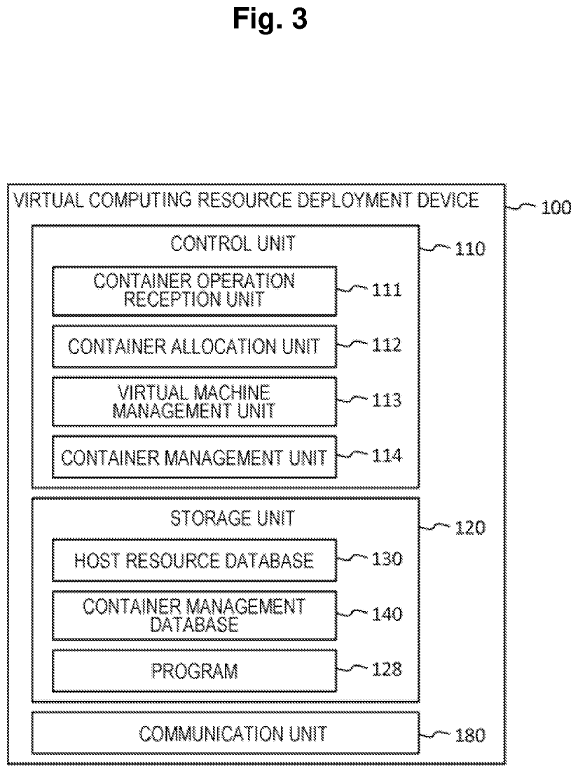

FIG. 3 is a functional block diagram of the virtual computing resource deployment device 100 according to the first embodiment. The virtual computing resource deployment device 100 is a computer and includes a control unit 110, a storage unit 120, and a communication unit 180. The communication unit 180 includes a communication device and can perform data communication with a user's terminal 870 (refer to FIG. 1) and the host computer 200.

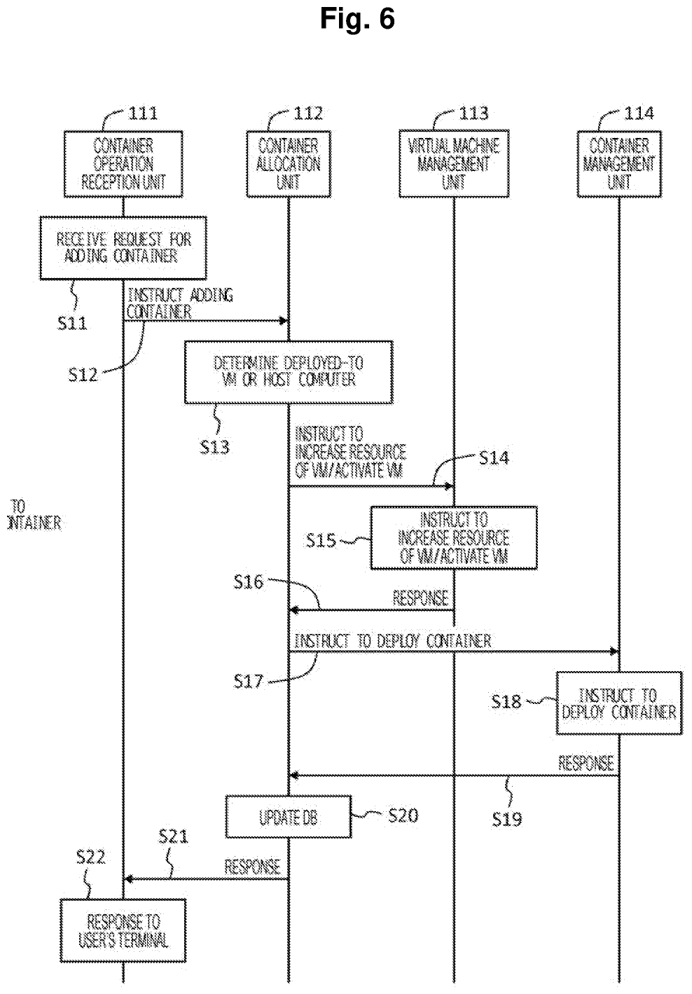

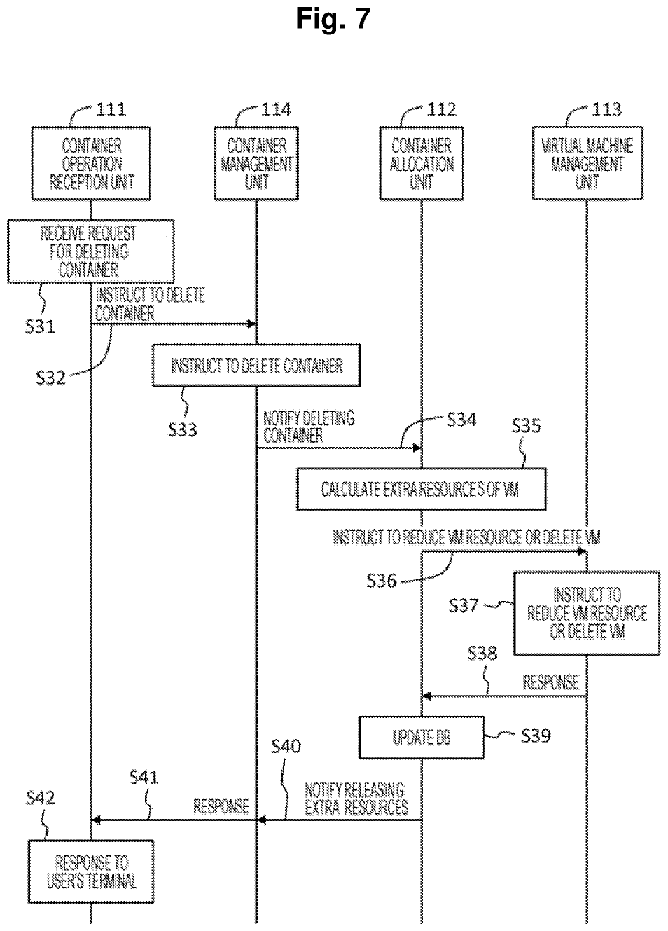

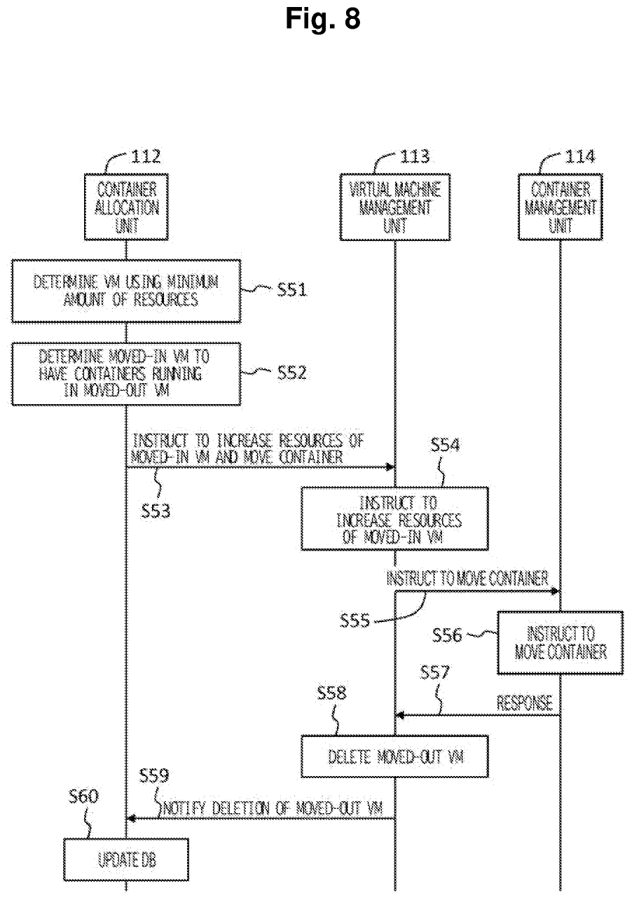

The storage unit 120 includes a storage device such as a read only memory (ROM), a random access memory (RAM), and a solid state drive (SSD). The storage unit 120 stores a host resource database 130, a container management database 140, and a program 128. The program 128 includes coding of a container addition process (refer to FIG. 6), a container deletion process (refer to FIG. 7), and a container deployment optimization process (refer to FIG. 8) to be described below.

### Virtual Computing Resource Deployment Device: Host Resource Database

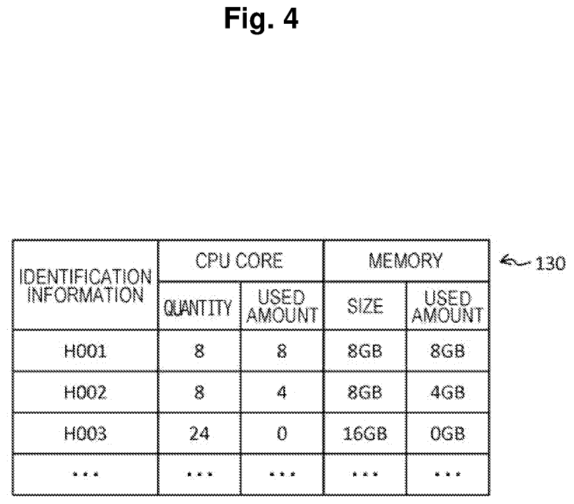

FIG. 4 is a data formation chart of the host

resource database 130 according to the first embodiment. The host resource database 130 comprises data in a tabular format, for example, and one row (record) indicates a resource status of the host computer 200. The record includes columns (attributes) of identification information of the host computer 200, the number of central processing unit (CPU) cores, a used amount of CPU cores, a memory size, and a used amount of memory. The number of unused CPU cores is [(the number of CPU cores)—(the used amount of CPU cores)], and an unused amount of memory is [(the memory size)—(the used amount of memory)].

### Virtual Computing Resource Deployment Device: Container Management Database

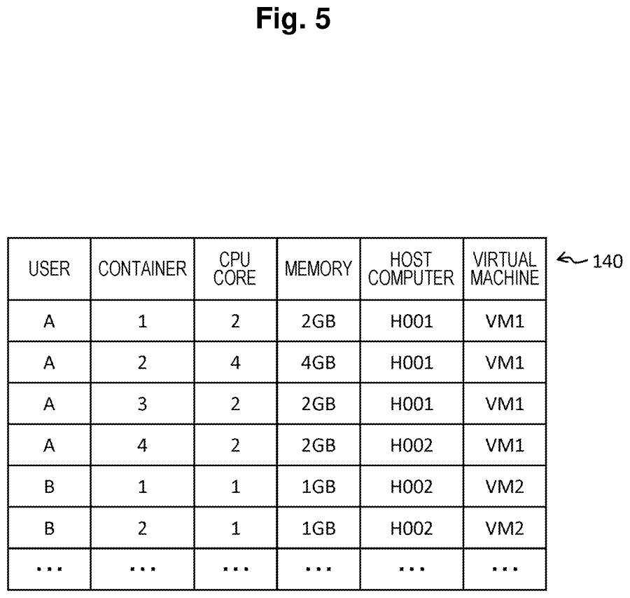

FIG. 5 is a data formation chart of the container management database 140 according to the first embodiment. The container management database 140 comprises data in a tabular format, for example, and one record indicates information regarding a container in operation. The record includes attributes of a user, a container, a CPU core, memory, a host computer, and a virtual machine.

The user indicates identification information of a user who has requested to add (activate or deploy) the container 252. The container indicates identification information of the container 252 for each user. The CPU core indicates the number of CPU cores used by (allocated to) the container 252, including the number of CPU cores used by the application 251 running on the container 252. The memory indicates a memory size used by (allocated to) the container 252, including a memory used by the application 251 running on the container 252.

The virtual machine indicates identification

information of the virtual machine 250 for each host computer 200, in which the container 252 runs. The host computer indicates identification information of the host computer 200 in which the virtual machine 250 runs, and corresponds to the identification information in the host resource database 130 (refer to FIG. 4).

### Virtual Computing Resource Deployment Device: Control Unit

Returning to FIG. 3, the control unit 110 is described. The control unit 110 is composed of one or more CPUs and includes a container operation reception unit 111, a container allocation unit 112, a virtual machine management unit 113, and a container management unit 114. The container operation reception unit 111 receives a request for adding (activating or deploying) or deleting (stopping) a/the container from the user's terminal 870.

In response to an instruction of adding the container 252, the container allocation unit 112 determines the virtual machine 250 (user-use virtual machine) in which the container 252 for the user who is the same as the user having instructed the addition. At this time, the container allocation unit 112 adjusts an amount of resources of the virtual machine 250. For example, the container allocation unit 112 determines the number of CPU cores and a memory size necessary for running the container 252 and the application 251, and instructs the virtual machine management unit 113, to be described below, to add/increase the resources to the virtual machine 250. Furthermore, when the container 252 has been deleted, the container allocation unit 112 determines the number of CPU cores and the memory size used by the container 252 and the application 251, and instructs the virtual machine management unit 113 to delete the resources from the virtual machine 250.

The virtual machine management unit 113 instructs the hypervisor 211 (refer to FIG. 2) of the host computer 200 to run or running the virtual machine 250, to activate or stop (delete) the virtual machine 250 and increase or decrease the resources. The container management unit 114 instructs the container base 253 to activate (add or deploy) or stop (delete) the container 252, as well as the application 251 and to move the container 252 between the virtual machines 250. Hereinbelow, detailed processing of the container operation reception unit 111, the container allocation unit 112, the virtual machine management unit 113, and the container management unit 114 is described with reference to the sequence diagram. Note that, in the drawings to be described below, the virtual machine is also referred to as a VM.

### Container Addition Process

FIG. 6 is a sequence diagram of the container addition process according to the first embodiment. With reference to FIG. 6, processing of the virtual computing resource deployment device 100 is described when a request for adding the container 252 is put in from the user's terminal 870.

In step S11, the container operation reception unit 111 receives a request for adding the container 252 (new container) from the user's terminal 870 used by the user. The addition request includes, for example, identification information of an image of the container 252, the number of CPU cores to be used, and a memory size. The number of CPU cores is not necessarily limited to a natural number and may be a decimal number such as 0.4 or 1.5. In step S12, the container operation reception unit 111 instructs the container allocation unit 112 to add the requested container 252d. The instruction includes identification information of the user who has put in the addition request.

In step S13, the container allocation unit 112 determines a virtual machine 250 (also referred to as a deploying virtual machine) in which the container 252 as instructed to add is deployed or a host computer 200 to run the new virtual machine 250 to deploy the container 252. More specifically, the container allocation unit 112 refers to the container management database 140 (refer to FIG. 5) and the host resource database 130 (refer to FIG. 4) and searches for (explore or find) the virtual machine 250 which is a virtual machine 250 (user-use virtual machine) to be used by the user having requested for addition and to run in the host computer 200 having unused resources (extra resources) to be used by the container 252 requested for addition. When such a virtual machine 250 does not exist, the container allocation unit 112 determines the host computer 200 which is not running any user-use virtual machine and activates the new virtual machine 250 having capability to run the container 252 requested for addition.

Here is example processing in step S13. It is assumed that the user who has requested for addition is “A”, the number of requested CPU cores is one, and the memory size is one GB. For the virtual machine 250 of “VM1” which is used by “A” and runs on the host computer 200 of “H001,” there is no unused resources in the host computer 200 of “H001” (refer to record having “H001” in FIG. 4). Therefore, the container 252 cannot be deployed in this virtual machine 250.

For the virtual machine 250 of “VM1” which is used by “A” and runs on the host computer 200 of “H002,” the host computer 200 has unused resources (refer to record having “H002” in FIG. 4). The container allocation unit 112 determines to deploy the container 252 as requested for addition in the virtual machine 250 of “VM1” on the host computer 200 of “H002.”

If the host computer 200 of “H002” does not have resources of one CPU core and one GB of memory, the container allocation unit 112 determines to newly activate a virtual machine 250 on the host computer 200 of “H003” and deploy the requested container 252 in the virtual machine 250. Note that a used amount of CPU cores and a used amount of memory of the host computer 200 of “H003” are each zeros, so that the virtual machine 250 is not running, indicating that no user-use virtual machine is running.

In step S14, the container allocation unit 112 instructs the virtual machine management unit 113 to increase resources of the deploying virtual machine determined in step S13 or activate the new virtual machine 250. This instruction includes identification information of the host computer 200 to run the intended deploying virtual machine, identification information of the deploying virtual machine, and an amount of resources to be increased (extra resources). Furthermore, in a case where the new virtual machine 250 is activated, the instruction includes identification information of the host computer 200 to run the virtual machine and an amount of resources used by the container 252 as well as the application 251.

In step S15, the virtual machine management unit 113 instructs the hypervisor 211, running in the host computer 200 instructed in step S14, to increase the resources of the deploying virtual machine or activate the new virtual machine 250. In step S16, upon receiving a response to increasing the resources or activating the new virtual machine 250 from the hypervisor 211, the virtual machine management unit 113 returns a response to the container allocation unit 112. This response may include identification information of the virtual machine 250 having the resources increased or the newly activated virtual machine 250.

In step S17, the container allocation unit 112 instructs the container management unit 114 to add the container 252 to the deploying virtual machine having the resources increased or to the new virtual machine 250. In step S18, the container management unit 114 instructs the container base 253 of the virtual machine 250 instructed in step S17 to deploy the container 252 requested for addition. In step S19, upon receiving a response to deploying the container 252 from the container base 253, the container management unit 114 returns a response to the container allocation unit 112. This response may include identification information of the deployed container 252.

In step S20, the container allocation unit 112 updates the host resource database 130 and the container management database 140 (described as DB in FIG. 6). More specifically, the container allocation unit 112 adds information regarding the deployed container 252 to the container management database 140 (refer to FIG. 5). Furthermore, the container allocation unit 112 updates the used amount in the host resource database 130 (refer to FIG. 4) so as to increase a used amount of the resources increased for the deploying virtual machine or a used amount of resources to be used by the newly activated virtual machine 250.

In step S21, the container allocation unit 112 returns a response to the instruction of adding the container 252 (refer to step S12) to the container operation reception unit 111. This response may include identification information of the deployed container 252. In step S22, the container operation reception unit 111 returns a response to the request for adding the container 252 (refer to step S11) to the user's terminal 870. This response may include identification information of the deployed container 252.

### Container Deletion Process

FIG. 7 is a sequence diagram of the container deletion process according to the first embodiment. With reference to FIG. 7, processing of the virtual computing resource deployment device 100 is described when a request for deleting the container 252 is put in from the user's terminal 870.

In step S31, the container operation reception unit 111 receives a request for deleting the container 252 from the user's terminal 870. The deletion request includes identification information of the container 252 aimed for deletion (aimed-for-deletion container). In step S32, the container operation reception unit 111 instructs the container management unit 114 to delete the requested container 252.

In step S33, the container management unit 114 instructs the container base 253 of the virtual machine 250, running the instructed container 252, to stop and delete the container 252. In step S34, the container management unit 114 notifies the container allocation unit 112 that the container 252 has been deleted.

In step S35, the container allocation unit 112 refers to the container management database 140 (refer to FIG. 5) and calculates extra resources (resources used by the container 252 as well as the application 251) of the virtual machine 250 from the deleted the container 252. In a case where there is no container 252 in the virtual machine 250 other than the deleted container 252, the virtual machine 250 is deleted, to add the resources used by the virtual machine 250 to the extra resources. Hereinbelow, the virtual machine 250 in which the deleted container 252 has been in operation is referred to as a subject virtual machine.

In step S36, the container allocation unit 112 instructs the virtual machine management unit 113 to reduce resources of the subject virtual machine or to delete the subject virtual machine. This instruction includes identification information of the subject virtual machine, identification information of a host computer 200 running the subject virtual machine, and an amount of the extra resources to be reduced from the subject virtual machine when the extra resources are reduced.

In step S37, the virtual machine management unit 113 instructs the hypervisor 211 running in the host computer 200 to reduce the resources of the virtual machine 250 or to delete the virtual machine 250. In step S38, upon receiving the response to the instruction of reducing the resources or deleting the virtual machine 250 from the hypervisor 211, the virtual machine management unit 113 returns a response to the container allocation unit 112.

In step S39, the container allocation unit 112 updates the host resource database 130 and the container management database 140 (described as DB in FIG. 7). More specifically, the container allocation unit 112 deletes information regarding the deleted container 252 from the container management database 140 (refer to FIG. 5). Furthermore, the container allocation unit 112 updates the used amount in the host resource database 130 (refer to FIG. 4) so as to reduce the used amount by the amount of the extra resources calculated in step S35.

In step S40, the container allocation unit 112 notifies the container management unit 114 that the extra resources due to the deletion of the container 252 has been released. In step S41, the container management unit 114 returns a response to the instruction of deleting the container 252 (refer to step S32) to the container operation reception unit 111. In step S42, the container operation reception unit 111 returns a response to the instruction of deleting the container 252 (refer to step S31) to the user's terminal 870.

### Container Deployment Optimization Process

When the container 252 has been deleted, the virtual machines 250 running the containers 252 for the same user may be dispersed in the plurality of host computers 200. In order to improve efficiency of resource usage, it is desirable that the containers 252 for the same user run in as few virtual machines 250 as possible. Hereinbelow, a container deployment optimization process to reduce the running virtual machines 250 in number (aggregate virtual machines 250 used by the same user) by moving the containers 252 between the virtual machines 250 is described.

FIG. 8 is a sequence diagram of the container deployment optimization process according to the first embodiment. The container deployment optimization process is executed at a predetermined timing for each host computer 200, for example, at a periodically repeated timing. Hereinbelow, the container deployment optimization process for the single host computer 200 (hereinafter, described as a subject host computer) is described.

In step S51, the container allocation unit 112 determines the virtual machine 250 which runs in the subject host computer and uses the minimum amount of resources. The amount of resources used by a virtual machine 250 is calculated by summing the number of CPU cores and memory sizes of the containers 252 running in the virtual machine 250, with reference to the container management database 140 (refer to FIG. 5), to allow for determining the virtual machine 250 having the minimum sum. The virtual machine 250 having the minimum sum may be one having the minimum sum of CPU cores, may be one having the minimum sum of memory sizes, or may be one having the minimum sum of the number of CPU cores and memory sizes weighted by predetermined values. Hereinbelow, the virtual machine 250 having the minimum sum is described as a moved-out virtual machine.

In step S52, the container allocation unit 112 determines the virtual machine 250 into which the container 252 running in the moved-out virtual machine is moved. More specifically, the container allocation unit 112 refers to the container management database 140 (refer to FIG. 5) and the host resource database 130 (refer to FIG. 4) and performs the following search, for each container 252 running in the moved-out virtual machine. That is, the container allocation unit 112 searches for the virtual machine 250 used by the same user as the moved-out virtual machine and running in the host computer 200 having unused resources to be used by said container 252. Note that when a plurality of containers 252 are moved to the single virtual machine 250, the host computer 200 needs to have unused resources to be used by the plurality of containers 252. When there is any container 252 for which no virtual machine has not been found, the container allocation unit 112 ends the container deployment optimization process. Hereinbelow, the virtual machine 250 to have the container 252 moved thereinto is described as a moved-in virtual machine. A plurality of moved-in virtual machines may exist in some cases. In this case, the containers 252 running in the moved-out virtual machine are dispersedly moved into the plurality of moved-in virtual machines.

In step S53, the container allocation unit 112 instructs the virtual machine management unit 113 to increase resources of the moved-in virtual machine and to move the container. This instruction includes identification information of the host computer 200 running the subject virtual machine 250 and an amount of resources to be increased (amount of resources to be used by the moved-in container 252).

In step S54, the virtual machine management unit 113 instructs the hypervisor 211 running in the host computer 200 instructed in step S53 to increase the resources of the virtual machine 250. In step S55, the virtual machine management unit 113 instructs the container management unit 114 to move the container 252 from the moved-out virtual machine to the moved-in virtual machine.

In step S56, the container management unit 114 instructs the one or more container bases 253 to move the one or more containers 252 from the moved-out virtual machine to the one or more moved-in virtual machines. In step S57, upon receiving a response to the instruction of moving the one or more containers 252 from the one or more container bases 253, the container management unit 114 returns a response to the virtual machine management unit 113.

In step S58, upon receiving the response, the virtual machine management unit 113 instructs the hypervisor 211 (refer to FIG. 2) of the host computer 200 running the moved-out virtual machine to stop and delete the moved-out virtual machine. In step S59, the virtual machine management unit 113 notifies the container allocation unit 112 of the deletion of the moved-out virtual machine associated with the movement of the container 252.

In step S60, the container allocation unit 112 updates the host resource database 130 and the container management database 140 (described as DB in FIG. 8). More specifically, the container allocation unit 112 updates an attribute of the virtual machine and an attribute of the host computer for the moved container 252 respectively with identification information of the moved-in virtual machine and identification information of the host computer 200 to run the moved-in virtual machine. Next, the container allocation unit 112 updates the used amount in the host resource database 130 (refer to FIG. 4) of the host computer 200, in which the moved-out virtual machine has been running, so as to reduce the resources used by the moved-out virtual machine. Furthermore, the container allocation unit 112 updates the used amount in the host resource database 130 of the host computer 200, in which the moved-in virtual machine runs, so as to increase the resources increased in the moved-in virtual machine.

This completes the description of the container deployment optimization process. The container deployment optimization process is sequentially executed for all the host computers 200. After a round, there may be a case where a host computer 200 had no extra resources when initially searched, but now has extra resources as a result of the containers having been gradually moved. In consideration of such a case, the container deployment optimization process may be repeatedly executed for each of the host computers 200 again after having been executed for the respective host computers 200.

### Features of Virtual Computing Resource Deployment Device

Upon receiving a request for adding the container 252 from the user, the virtual computing resource deployment device 100 increases the resources of the virtual machine 250 (virtual machine used for the user, user-use virtual machine) running the container 252 for the user and adds the container 252. When there is no virtual machine 250 or the resources cannot be added, the virtual computing resource deployment device 100 newly activates the virtual machine 250 and deploys the container 252 in the virtual machine 250.

Upon receiving a request for deleting the container 252, the virtual computing resource deployment device 100 deletes the container 252 and reduces the amount of the resources used by the container 252 from the resources of the virtual machine 250 in which the container 252 has been running. Furthermore, the virtual computing resource deployment device 100 moves the container 252 between the virtual machines 250 used by the same user, to reduce the running virtual machines 250 in number.

Deploying the containers 252 in this way causes the users of the containers 252 running in the single virtual machine 250 to be identical. The containers 252 for distinct users respectively run in the distinct virtual machines 250, to secure security equivalent to conventional ones. In addition, the amount of resources of the virtual machine 250 is adjusted in accordance with the addition or deletion of the container 252, to allow the virtual machine 250 to run with the minimum resources necessary for running the container 252. Further, the host computer 200 has the single virtual machine used by the single user. This achieves a high resource utilization rate.

Second Embodiment In the first embodiment, the virtual computing resource deployment device 100 increases or decreases the amount of resources of the virtual machine 250 in accordance with the addition or the deletion of the container 252. Depending on a virtualization technique or the hypervisor 211, there may be a case where the amount of resources of the virtual machine 250 in operation cannot be increased or decreased. The virtual computing resource deployment device 100 according to a second embodiment activates a virtual machine 250 to which the increased/decreased amount of resources is allocated, moves the container to the virtual machine 250, and deletes the moved-out virtual machine 250, to increase or decrease the amount of resources. Hereinbelow, a container addition process and a container deletion process according to the second embodiment are described.

### Second Embodiment: Container Addition Process

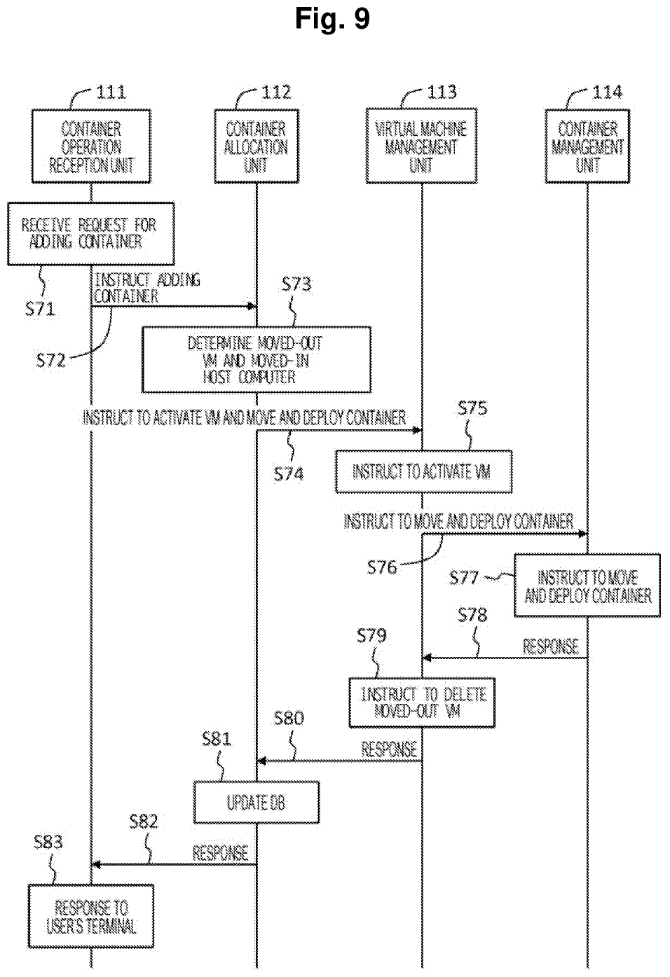

FIG. 9 is a sequence diagram of the container addition process according to the second embodiment. Steps S71 and S72 are similar to steps S11 and S12 (refer to FIG. 6) of the container addition process according to the first embodiment.

In step S73, the container allocation unit 112 determines a virtual machine 250 to deploy an additional container 252 as instructed and a host computer 200 to run the virtual machine 250 after deployment. More specifically, the container allocation unit 112 refers to the container management database 140 (refer to FIG. 5) and host resource database 130 (refer to FIG. 4) to execute the following search. That is, the container allocation unit 112 searches for a virtual machine 250 used by a user who has requested for addition and running in a host computer 200 having unused resources (hereinbelow, referred to as new resources) as many as the sum of an amount of resources used by the virtual machine 250 and an amount of resources for the container 252 to be added.

When the virtual machine 250 is found and the host computer 200, having the new resources, does not run any virtual machine 250 for the user who has requested for addition, the container allocation unit 112 sets the virtual machine 250 as a moved-out virtual machine and sets the host computer 200 as a moved-in host computer. When the virtual machine 250 is found and the host computer 200 having the new resource is one running the virtual machine 250, the virtual machine 250 is set as the moved-out virtual machine, and the host computer 200 is set as the moved-in host computer.

In a case other than the above two cases or when the host computer 200 having the new resources does not exist, the next search is executed. That is, the container allocation unit 112 searches for the host computer 200 not running any virtual machine 250 for the user who has requested for addition and being available for running a new virtual machine 250 to run the container 252 as requested for addition, and sets the host computer 200 as the moved-in host computer. In this case, there is no moved-out virtual machine.

In step S74, the container allocation unit 112 instructs the virtual machine management unit 113 to activate a virtual machine in the moved-in host computer determined in step S73, to move the container 252 running in the moved-out virtual machine, and to deploy the container 252 as requested for addition. In step S75, the virtual machine management unit 113 instructs the hypervisor 211 (refer to FIG. 2) running in the moved-in host computer to activate a new virtual machine 250. An amount of resources of the virtual machine 250 is an amount of resources equal to the new resources when the moved-out virtual machine exists, and is an amount of resources to allow for running the container 252 as requested for addition when no moved-out virtual machine exists. The activated virtual machine 250 is described as a moved-in virtual machine.

In step S76, the virtual machine management unit 113 instructs the container management unit 114 to move the container 252 running in the moved-out virtual machine and to deploy the container 252 as requested for addition. In step S77, when the moved-out virtual machine exists, the container management unit 114 instructs the moved-out virtual machine and the container base 253 of the moved-in virtual machine to move the container 252 running in the moved-out virtual machine to the moved-in virtual machine. Furthermore, the container management unit 114 instructs the container base 253 of the moved-in virtual machine to deploy the container 252 as requested for addition in the moved-in virtual machine.

In step S78, the container management unit 114 returns a response to the instruction of moving and deploying the container (refer to step S76) to the virtual machine management unit 113. This response may include identification information of the added container 252. In step S79, the virtual machine management unit 113 instructs the hypervisor 211 of the host computer 200, having run the moved-out virtual machine, to delete the moved-out virtual machine. Note that when no moved-out virtual machine exists, step S79 is skipped.

In step S80, the virtual machine management unit 113 returns a response to the instruction of activating the virtual machine and moving and deploying the container (refer to step S74) to the container allocation unit 112. This response may include identification information of the added container 252.

In step S81, upon receiving the response, the container allocation unit 112 updates the host resource database 130 and container management database 140 (described as DB in FIG. 9). More specifically, the container allocation unit 112 updates attributes of the host computer and virtual machine for the moved container 252. Furthermore, the container allocation unit 112 adds information regarding the added container 252.

The container allocation unit 112 updates the used amounts of CPU cores and memory of the moved-in host computer so as to be increased by those of the activated moved-in virtual machine. Furthermore, when the moved-out virtual machine exists, the container allocation unit 112 updates the used amounts of CPU cores and memory of the host computer 200, in which the moved-out virtual machine has been in operation, so as to be reduced by those of the moved-out virtual machine.

In step S82, the container allocation unit 112 returns a response to the instruction (step S72) of adding the container 252 to the container operation reception unit 111. This response may include identification information of the added container 252.

In step S83, the container operation reception unit 111 returns a response to the request (step S71) of adding the container 252 to the user's terminal 870 (refer to FIG. 1). This response may include identification information of the added container 252.

### Second Embodiment: Container Deletion Process

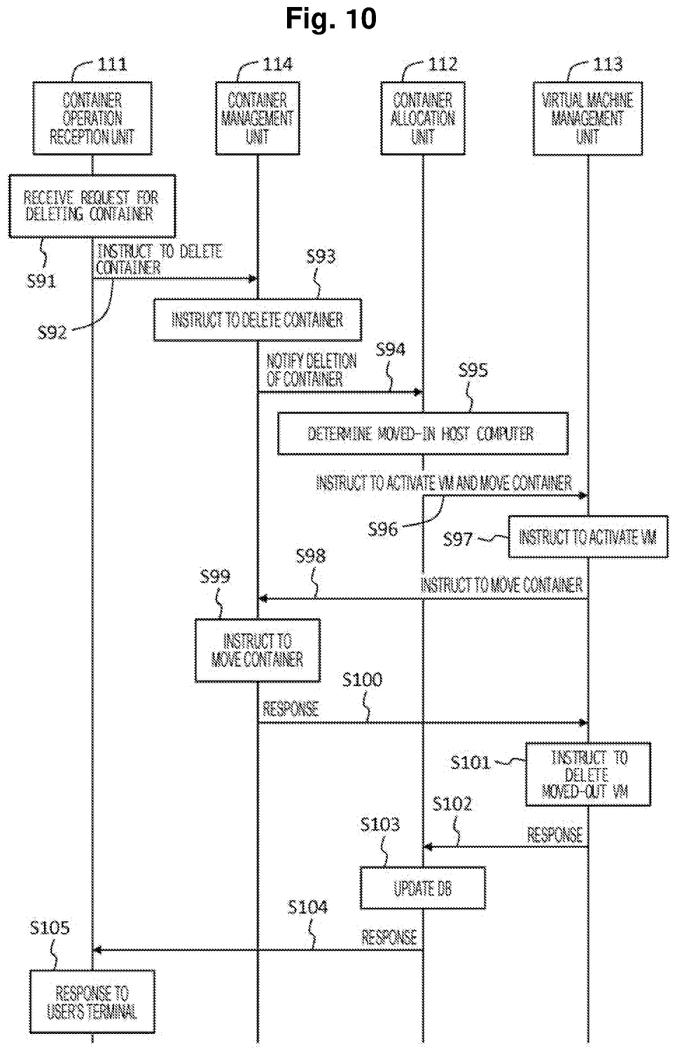

FIG. 10 is a sequence diagram of the container deletion process according to the second embodiment. Steps S91 to S94 are similar to steps S31 to S34 (refer to FIG. 7) of the container deletion process according to the first embodiment. Hereinbelow, the virtual machine in which the container 252 has been in operation is described as a moved-out virtual machine. Furthermore, it is assumed that the container 252 is in operation in the moved-out virtual machine. A case where there is no container 252 in operation is described below.

In step S95, the container allocation unit 112 determines a moved-in host computer. More specifically, the container allocation unit 112 refers to the container management database 140 (refer to FIG. 5) to calculate resources (hereinbelow, described as necessary resources) necessary, after the container 252 has been deleted, for running the virtual machine 250 in which the container 252 has been in operation. Next, the container allocation unit 112 refers to the container management database 140 (refer to FIG. 5) and host resource database 130 (refer to FIG. 4) to execute the following search. That is, the container allocation unit 112 searches for a host computer 200 having unused necessary resources and not running any virtual machine 250 for the user who has requested for deletion. This host computer 200 to be searched may be one running the virtual machine 250 from which the container 252 has been deleted. This host computer 200 is described as a moved-in host computer. Hereinbelow, a description is continued, assuming that the moved-in host computer has been found. A case where the moved-in host computer has not been found is described below.

In step S96, the container allocation unit 112 instructs the virtual machine management unit 113 to newly activate the virtual machine 250 having the necessary resources in the moved-in host computer and to move the container 252 from the moved-out virtual machine to the newly activated virtual machine 250. Hereinbelow, the newly activated virtual machine 250 is described as a moved-in virtual machine.

In step S97, the virtual machine management unit 113 instructs the hypervisor 211 running in the moved-in host computer to activate the moved-in virtual machine having the necessary resources. In step S98, upon receiving a response to the instruction of activating the moved-in virtual machine from the hypervisor 211, the virtual machine management unit 113 instructs the container management unit 114 to move the container 252.

In step S99, the container management unit 114 instructs the moved-out virtual machine and the container base 253 of the moved-in virtual machine to move the container 252 running in the moved-out virtual machine to the moved-in virtual machine. In step S100, the container management unit 114 returns a response to the instruction of moving the container to the virtual machine management unit 113.

In step S101, upon receiving the response, the virtual machine management unit 113 instructs the hypervisor 211 of the host computer 200 in which the moved-out virtual machine has been in operation to delete the moved-out virtual machine. In step S102, the virtual machine management unit 113 returns a response to the instruction of newly activating a virtual machine and moving the container (refer to step S96) to the container allocation unit 112.

In step S103, upon receiving the response, the container allocation unit 112 updates the host resource database 130 and container management database 140 (described as DB in FIG. 10). More specifically, the container allocation unit 112 deletes information regarding the deleted container 252 from the container management database 140 (refer to FIG. 5). Furthermore, the container allocation unit 112 updates attributes of the host computer and virtual machine for the moved container 252.

Next, the container allocation unit 112 updates the used amounts of CPU cores and memory of the moved-in host computer so as to be increased by those (necessary resource) of the activated moved-in virtual machine. Furthermore, the container allocation unit 112 updates the used amounts of the CPU cores and memory of the host computer 200, in which the moved-out virtual machine has been in operation, so as to be reduced by those of the moved-out virtual machine.

In step S104, the container allocation unit 112 returns a response to the instruction of deleting the container 252 (refer to step S92) to the container operation reception unit 111. In step S105, the container operation reception unit 111 returns the response to the request of deleting the container 252 (refer to step S91) to the user's terminal 870.

When there is no container 252 in operation in steps S91 to S94, the container allocation unit 112 instructs the virtual machine management unit 113 to delete the virtual machine 250 (moved-out virtual machine) in which the deleted container 252 has been in operation. Next, the container allocation unit 112 proceeds to step S103 and updates the host resource database 130 and container management database 140. More specifically, the container allocation unit 112 deletes information regarding the deleted container 252 from the container management database 140 (refer to FIG. 5).

Furthermore, the container allocation unit 112 updates the used amounts of the CPU cores and memory of the host computer 200, in which the moved-out virtual machine has been running, so as to be reduced by those of the moved-out virtual machine.

When the moved-in host computer is not found in step S95, the container allocation unit 112 proceeds to step S103 and updates the container management database 140. More specifically, the container allocation unit 112 deletes information regarding the deleted container 252 from the container management database 140 (refer to FIG. 5). In this case, the virtual machine 250 in which the deleted container 252 has been in operation has the resources used by the deleted container 252 as extra resources.

### Second Embodiment: Features of Virtual Computing Resource Deployment Device

The virtual computing resource deployment device 100 according to the second embodiment newly activates the virtual machine 250 having the increased/decreased amount of resources and moves the container 252, instead of directly (while the virtual machine 250 being in operation) increasing/decreasing the amount of resources of the virtual machine 250 as with the first embodiment, to implement increasing/decreasing amount of resources of the virtual machine 250. This allows for adjusting the amount of resources of the virtual machine 250 in accordance with adding/deleting the container 252, to achieve a high resource utilization rate.

### Second Embodiment: Container Deployment Optimization Process

The container deployment optimization process of the second embodiment, although not described, can be executed almost similarly to the first embodiment. Specifically, instead of increasing resources of the virtual machine 250 in step S54 (refer to FIG. 8), the virtual machine 250 having increased resources may be newly activated, and the moved-out virtual machine and the containers 252 to run in the moved-in virtual machine (refer to step S52) may be moved to the newly activated virtual machine 250.

Note that in case of the first embodiment, the container 252 is moved to the moved-in virtual machine. In case of the second embodiment, a moved-in virtual machine is newly activated as a virtual machine having resources increased to the resources of the moved-in virtual machine (second moved-out virtual machine) in case of the first embodiment, and the container 252 to run in the second moved-out virtual machine and (some) containers 252 in operation in the moved-out virtual machine are moved to the moved-in virtual machine in case of the second embodiment. Furthermore, it is assumed that the host computer 200 to newly run the virtual machine 250 has no virtual machine 250 (second user-use virtual machine) for the same user, except the moved- out virtual machine and the second moved-out virtual machine.

### Modifications

### Modification due to Units of Increasing/Decreasing Resources

With the embodiments described above, when the container 252 is added to the virtual machine 250, the amount of resources of the virtual machine 250 is increased (refer to step S15 in FIG. 6). Depending on the virtualization technique (hypervisor 211), a unit of the amount of resources allocated to the virtual machine 250 may be coarse to cause the virtual machine 250 to have extra resources. For example, there is a case where an allocation unit of the CPU core is two, to have a surplus of 0.5. If an additional container 252 can run within the extra resources, the virtual computing resource deployment device 100 may deploy the container 252 without increasing the resources.

Furthermore, even if the container 252 is deleted to have the extra resources, reducing the resources by the minimum unit may not secure resources necessary for running the remaining containers 252, because the unit amount of resources allocated to the virtual machine 250 is coarse. In such a case, reducing the resources of the virtual machine 250 (refer to steps S36 to S38 in FIG. 7) is not executed.

### Other Modifications

Hereinabove, several embodiments of the present invention have been described, but these embodiments are merely examples and are not intended to limit the technical scope of the present invention. For example, in the container deletion process illustrated in FIG. 7, the container operation reception unit 111 instructs the container management unit 114 to delete the container, but may instruct the container allocation unit 112 to delete the container. The instructed container allocation unit 112 may instruct the virtual machine management unit 113 to delete the container 252.

Furthermore, the container operation reception unit 111, container allocation unit 112, virtual machine management unit 113, and container management unit 114 included in the control unit 110 may be combined or divided. For example, the container allocation unit 112 and the container management unit 114 may be combined to form a container management unit. With the above embodiment, the resources includes the CPU cores and memory, but other resources may be considered to search for a destination for adding and/or moving a container. For example, a network capacity (network bandwidth) may be included in the resources.

The present invention can be implemented with various other embodiments, and can be variously modified with elimination and/or substitution without departing from the scope of the present invention. These embodiments and modifications thereof are included in the scope of the invention described in the present specification and the like, and are included in the scope of the invention described in the claims and equivalents to the aforementioned scope.

### Hardware Configuration

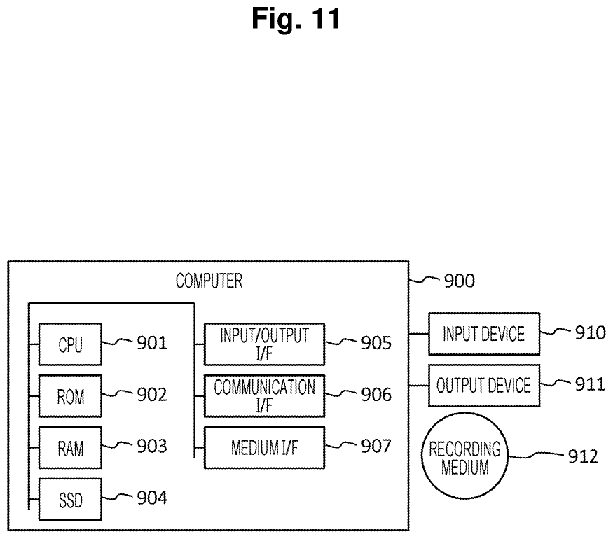

The virtual computing resource deployment devices 100 according to the first and second embodiments are each implemented by a computer 900 having a configuration as illustrated in FIG. 11, for example. FIG. 11 is a hardware configuration diagram illustrating an example of the computer 900 that implements the functions of the virtual computing resource deployment device 100 according to each of the first and second embodiments. The computer 900 includes a CPU 901, a ROM 902, a RAM 903, an SSD 904 (described as SSD in FIG. 11), an input/output interface 905 (described as input/output I/F in FIG. 11), a communication interface 906 (described as communication I/F in FIG. 11), and a medium interface 907 (described as medium I/F in FIG. 11). The computer 900 may include a hard disc drive (HDD) instead of the SSD 904 and may further include an HDD in addition to the SSD 904.

The CPU 901 operates on the basis of a program stored in the ROM 902 or the SSD 904, to execute control by the control unit 110 in FIG. 3. The ROM 902 stores a boot program executed by the CPU 901 when the computer 900 is activated, a program related to hardware of the computer 900, and the like. The CPU 901 controls an input device 910 such as a mouse and a keyboard and an output device 911 such as a display and a printer via the input/output interface 905. The CPU 901 acquires data from the input device 910 and outputs generated data to the output device 911 via the input/output interface 905.

The SSD 904 stores a program to be executed by the CPU 901, data to be used by the program, and the like. The communication interface 906 receives data from another device (for example, host computer 200, user's terminal 870, or the like), not illustrated, via a communication network and outputs the data to the CPU 901, and transmits data generated by the CPU 901 to said another device via the communication network. The medium interface 907 retrieves a program or data stored in a recording medium 912 and outputs the program or data to the CPU 901 via the RAM 903. The CPU 901 loads the program from the recording medium 912 into the RAM 903 via the medium interface 907, and executes the loaded program. The recording medium 912 is an optical recording medium such as a digital versatile disk (DVD), a magneto-optical recording medium such as a magneto optical disk (MO), a magnetic recording medium, a conductor memory tape medium, a semiconductor memory, or the like.

For example, in a case where the computer 900 functions as the virtual computing resource deployment device 100 according to the present embodiment, the CPU 901 of the computer 900 executes the program 128 (refer to FIG. 3) loaded into the RAM 903 to implement the functions of the virtual computing resource deployment device 100. The CPU 901 retrieves the program from the recording medium 912 and executes the program. In addition, the CPU 901 may retrieve the program from another device via the communication network, or may install the program 128 from the recording medium 912 to the SSD 904 and execute the program 128.

### Advantageous Effects

Advantageous effects of the device is described below. The virtual computing resource deployment device 100 according to each of the above-described embodiments deploys the container 252 to run in the virtual machine 250. The virtual computing resource deployment device 100 includes the container operation reception unit 111 to receive a request for adding a new container from the terminal (user's terminal 870) used by the user. The virtual computing resource deployment device 100 includes the container management unit (container allocation unit 112 and container management unit 114) to deploy the new container in the user-use virtual machine, as the virtual machine 250 to run the container added by request from the terminal used by the same user as one who has requested for addition.

The virtual computing resource deployment device 100 as described above causes the users of the containers 252 running in the single virtual machine 250 are identical. The containers 252 for the distinct users run in the distinct virtual machines 250, to allow for ensuring security (isolation between users) equivalent to that with a conventional technique. Furthermore, the host computer 200 runs a single virtual machine for a single user. This achieves a high resource utilization rate.

The virtual computing resource deployment device 100 according to the first embodiment further includes the virtual machine management unit 113 that manages activating and deleting the virtual machine 250 and increasing/decreasing resources. When the host computer 200 running the user-use virtual machine has a deployed-to virtual machine, as a user-use virtual machine having extra resources necessary for running the new container, the container management unit instructs the virtual machine management unit 113 to add the extra resources to the deployed-to virtual machine and deploy the new container in the deployed-to virtual machine. When there is no deployed-to virtual machine, the container management unit instructs the virtual machine management unit 113 to newly activate the virtual machine 250 having the extra resources in the host computer 200 running no user-use virtual machine, and deploys the new container in the virtual machine 250.

According to such a virtual computing resource

deployment device 100, the amount of resources of the virtual machine 250 is adjusted in accordance with the addition of the container 252, and the virtual machine 250 runs with the minimum resources necessary for running the container 252. This achieves a high resource utilization rate.

The virtual computing resource deployment device 100 according to the second embodiment further includes the virtual machine management unit 113 that manages activating and deleting the virtual machine 250. The container management unit obtains an amount of new resources as the sum of the amount of resources of the moved-out virtual machine, which is the user-use virtual machine, and the amount of resources necessary for running the new container, and finds (searches for) the moved-in host computer, as the host computer 200 having unused resources equal to or more than the amount of new resources. When the moved-in host computer is the host computer 200 running the moved-out virtual machine or the host computer 200 not running any user-use virtual machine, the container management unit instructs the virtual machine management unit 113 to activate the virtual machine 250 in the moved-in host computer having the amount of new resources, in the moved-in host computer, as a moved-in virtual machine, and moves the container running in the moved-out virtual machine to the moved-in virtual machine, deploys the new container in the moved-in virtual machine, and instructs the virtual machine management unit to delete the moved-out virtual machine. When there is no moved-in host computer, the container management unit instructs the virtual machine management unit to activate the virtual machine 250, having the extra resources necessary for running the new container, in the host computer 200 not running any user-use virtual machine, as a moved-in virtual machine, and deploys the new container in the moved-in virtual machine.

According to the virtual computing resource deployment device 100 as described above, the moved-in virtual machine, having the amount of resources adjusted in accordance with the addition of the container 252, runs the container 252 of the moved-out virtual machine and the new container. This achieves a high resource utilization rate.

The virtual computing resource deployment device 100 according to the first embodiment further includes the virtual machine management unit 113 that manages activating and deleting the virtual machine 250 and increasing/decreasing resources. The container operation reception unit 111 receives a request for deleting an aimed-for-deletion container, which has been the running container 252. The container management unit deletes the aimed-for-deletion container from the virtual machine 250 in which the aimed-for-deletion container has been running, and instructs the virtual machine management unit 113 to reduce the amount of resources used by the aimed-for-deletion container from the resources of the virtual machine 250.

According to the virtual computing resource deployment device 100 as described above, the amount of resources of the virtual machine 250 is adjusted in accordance with the deletion of the container 252, and the virtual machine 250 runs with the minimum resources necessary for running the container 252. This achieves a high resource utilization rate.

The virtual computing resource deployment device 100 according to the second embodiment further includes the virtual machine management unit 113 that manages activating and deleting the virtual machine 250. The container operation reception unit 111 receives a request for deleting an aimed-for-deletion container, which has been the running container 252. The container management unit deletes the aimed-for-deletion container from the moved-out virtual machine, as the virtual machine 250 in which the aimed-for-deletion container has been running, obtains the necessary amount of resources necessary for running the moved-out virtual machine after the deletion of the aimed-for-deletion container, and finds (searches for) the moved-in host computer, as the host computer 200 having unused resources equal to or more than the necessary amount of resources. When the moved-in host computer is the host computer 200 running the moved-out virtual machine or the host computer 200 not running any virtual machine used to run the container added by request from the terminal used by the same user as the user of the virtual machine in which the aimed-for-deletion container has been running, the container management unit instructs the virtual machine management unit 113 to activate the virtual machine 250 having the necessary amount of resources in the moved-in host computer, as the moved-in virtual machine, and to move one or more containers running in the moved-out virtual machine to the moved-in virtual machine, and instructs the virtual machine management unit to delete the moved-out virtual machine.

According to the virtual computing resource deployment device 100 as described above, the container 252, which has been in operation in the moved-out virtual machine, runs in the moved-in virtual machine having the amount of resources adjusted in accordance with the deletion of the container 252, after the deletion of the container to be deleted. This achieves a high resource utilization rate.

The virtual computing resource deployment device 100 according to the first embodiment further includes the virtual machine management unit 113 that manages activating and deleting the virtual machine 250 and increasing/decreasing resources. When there are one or more virtual machines running one or more containers added by request from the terminal used by the same user as the user of the terminal from which a request has been received for adding a container to run in the moved-out virtual machine, as the activated and deleted virtual machine 250, and running in the host computer having unused resources, allowing all the containers running in the moved-out virtual machine to be moved thereinto, with the unused resources added thereto, the container management unit instructs the virtual machine management unit 113 to increase the resources of the moved-in virtual machine and move the one or more containers 252 running in the moved-out virtual machine to the moved-in virtual machine, and instructs the virtual machine management unit 113 to delete the moved- out virtual machine.

According to the virtual computing resource deployment device 100 as described above, the container 252 can be moved between the virtual machines 250, to reduce the running virtual machines 250 in number (aggregate the virtual machines 250 used by the same user). This achieves a high resource utilization rate.

The virtual computing resource deployment device 100 according to the second embodiment further includes the virtual machine management unit 113 that manages activating and deleting the virtual machine 250. When there is a second moved-out virtual machine running as a second user-use virtual machine, including the one or more virtual machines 250 running the one or more containers 252 added by request from the terminal used by the same user as the user of the terminal from which a request has been received for adding the container 252 to run in the moved-out virtual machine, as the activated and deleted virtual machine 250, allowing all the containers 252 running in the moved-out virtual machine to be moved thereinto and run therein, with the resources thereof increased, and when there is a moved-in host computer, as the host computer 200 having unused resources to allow the moved- in virtual machine to run as the new virtual machine 250 having resources added to those of the second moved-out virtual machine, and running as the host computer 200 not running any other second user-use virtual machine which is different from the moved-out virtual machine and second moved-out virtual machine, the container management unit instructs the virtual machine management unit 113 to activate the moved-in virtual machine in the moved-in host computer, move the containers running in the moved-out virtual machine to the moved-in virtual machine, and move the container running in the second moved-out virtual machine to the moved-in virtual machine, and instructs the virtual machine management unit 113 to delete the moved-out virtual machine and second moved-out virtual machine.

According to the virtual computing resource deployment device 100 as described above, the container 252 can be moved between the virtual machines 250, to reduce the running virtual machines 250 in number (aggregate the virtual machines 250 used by the same user). This achieves a high resource utilization rate.

### REFERENCE SIGNS LIST

100 virtual computing resource deployment device
111 container operation reception unit
112 container allocation unit (container management unit)
113 virtual machine management unit
114 container management unit
200 host computer
250 virtual machine
252 container
870 user's terminal (terminal)

1. A virtual computing resource deployment device to deploy a container to run in a virtual machine, comprising:
a container operation reception unit that receives a request for adding a new container from a terminal used by a user; and
a container management unit that deploys the new container in a user-use virtual machine, as a virtual machine running a container added by request from a terminal used by the same user.

2. The virtual computing resource deployment device according to claim 1, further comprising:
a virtual machine management unit that manages activating and deleting the virtual machine and increasing/decreasing resources, wherein
the container management unit,
when a host computer running the user-use virtual machine has a deployed-to virtual machine, as a user-use virtual machine having extra resources necessary for running the new container,
instructs the virtual machine management unit to add the extra resources to the deployed-to virtual machine and deploys the new container in the deployed-to virtual machine, and when there is no deployed-to virtual machine,
instructs the virtual machine management unit to newly activate a virtual machine having the extra resources in a host computer running no user-use virtual machine, and deploys the new container in the virtual machine.

3. The virtual computing resource deployment device according to claim 1, further comprising:
a virtual machine management unit that manages activating and deleting a virtual machine, wherein
the container management unit
obtains an amount of new resources as a sum of an amount of resources of a moved-out virtual machine, which is the user-use virtual machine, and an amount of resources necessary for running the new container, and finds a moved-in host computer, as a host computer having unused resources equal to or more than the amount of new resources, and
when the moved-in host computer is a host computer running the moved-out virtual machine or a host computer not running any user-use virtual machine,
instructs the virtual machine management unit to activate a virtual machine, having the amount of new resources, in the moved-in host computer, as a moved-in virtual machine,
moves a container running in the moved-out virtual machine to the moved-in virtual machine,
deploys the new container in the moved-in virtual machine,
instructs the virtual machine management unit to delete the moved-out virtual machine, and
when there is no moved-in host computer,
instructs the virtual machine management unit to activate a virtual machine, having extra resources necessary for running the new container, in the host computer not running any user-use virtual machine, as a moved-in virtual machine, and
deploys the new container in the moved-in virtual machine.

4. The virtual computing resource deployment device according to claim 1, further comprising:
a virtual machine management unit that manages activating and deleting the virtual machine and increasing/decreasing resources, wherein
the container operation reception unit receives a request for deleting an aimed-for-deletion container, which has been a running container, and
the container management unit
deletes the aimed-for-deletion container from a virtual machine in which the aimed-for-deletion container has been running, and
instructs the virtual machine management unit to reduce an amount of resources used by the aimed-for-deletion container from resources of the virtual machine.

5. The virtual computing resource deployment device according to claim 1, further comprising:
a virtual machine management unit that manages activating and deleting a virtual machine, wherein
the container operation reception unit receives a request for deleting an aimed-for-deletion container, which has been a running container, and
the container management unit
deletes the aimed-for-deletion container from a moved-out virtual machine, as a virtual machine in which the aimed-for-deletion container has been running,
obtains a necessary amount of resources necessary for running the moved-out virtual machine after the deletion of the aimed-for-deletion container, and finds a moved-in host computer, as a host computer having unused resources equal to or more than the necessary amount of resources,
when the moved-in host computer is a host computer running the moved-out virtual machine or a host computer not running any virtual machine used to run a container added by request from a terminal used by the same user as a user of the virtual machine in which the aimed-for-deletion container has been running,
instructs the virtual machine management unit to activate a virtual machine having the necessary amount of resources in the moved-in host computer, as a moved-in virtual machine,
moves one or more containers running in the moved-out virtual machine to the moved-in virtual machine, and
instructs the virtual machine management unit to delete the moved-out virtual machine.

6. The virtual computing resource deployment device according to claim 1, further comprising:
a virtual machine management unit that manages activating and deleting a virtual machine and increasing/decreasing resources, wherein
the container management unit,
when there are one or more virtual machines running one or more containers added by request from a terminal used by the same user as a user of a terminal from which a request has been received for adding a container to run in a moved-out virtual machine, as the activated and deleted virtual machine, and running in a host computer having unused resources, allowing all containers running in the moved-out virtual machine to be moved thereinto, with the unused resources added thereto,
instructs the virtual machine management unit to increase resources of the moved-in virtual machine,
moves one or more containers running in the moved-out virtual machine to the moved-in virtual machine, and
instructs the virtual machine management unit to delete the moved-out virtual machine.

7. The virtual computing resource deployment device according to claim 1, further comprising:
a virtual machine management unit that manages activating and deleting a virtual machine, wherein
the container management unit,
when there is a second moved-out virtual machine running as a second user-use virtual machine, including one or more virtual machines running one or more containers added by request from a terminal used by the same user as a user of a terminal from which a request has been received for adding a container to run in a moved-out virtual machine, as the activated and deleted virtual machine, allowing all containers running in the moved-out virtual machine to be moved thereinto and run therein, with resources thereof increased, and
when there is a moved-in host computer, as a host computer having unused resources to allow a moved-in virtual machine to run as a new virtual machine having resources added to those of the second moved-out virtual machine, and running as a host computer not running any other second user-use virtual machine which is different from the moved-out virtual machine and second moved-out virtual machine,
instructs the virtual machine management unit to activate the moved-in virtual machine in the moved-in host computer,
moves the containers running in the moved-out virtual machine to the moved-in virtual machine,
moves a container running in the second moved-out virtual machine to the moved-in virtual machine, and
instructs the virtual machine management unit to delete the moved-out virtual machine and second moved-out virtual machine.

8. A non-transitory computer-readable medium storing a program which, when executed by one or more processors, causes the one or more processors to function as a virtual computing resource deployment device comprising:
a container operation receiver that receives a request for adding a new container from a terminal used by a user; and
a container manager that deploys the new container in a user-use virtual machine, as a virtual machine running a container added by request from a terminal used by the same user.

9. A virtual computing resource deployment method executed by a virtual computing resource deployment device, the method comprising:
a step of receiving a request for adding a new container from a terminal used by a user; and
a step of deploying the new container in a user-use virtual machine, as a virtual machine running a container added by request from a terminal used by the same user.
